(19) United States
(12) Patent Application Publication
(10) Pub. No.: US 2006/0001364 A1
(43) Pub. Date: Jan. 5, 2006

(54) Organic electroluminescent stereoscopic image display apparatus and fabricating method thereof

(75) Inventors: Ching-Ian Chao, Hsinchu (TW); Kuen Lee, Hsinchu (TW); Chao-Hsu Tsai, Hsinchu (TW)

Correspondence Address: Welsh & Katz, Ltd.;Eric D. Cohen, 22nd Floor, 120 South Riverside Plaza, Chicago, IL, 60606, US

(73) Assignee: Industrial Technology Research Institute, Hsinchu (TW)

(21) Appl. No.: 10/963,178

(22) Filed: Oct. 12, 2004

(30) Foreign Application Priority Data
Jun. 30, 2004 (TW) 93119818

(51) Int. Cl. H05B 33/00

(52) U.S. Cl. 313/506

(57) ABSTRACT

An organic electroluminescent stereoscopic image display apparatus includes a parallax layer and an organic electroluminescent device. The parallax layer is sited on the emission side of the organic electroluminescent device. The parallax layer transfers lights that are received by the right eye and left eye to be lights with different characteristics. A microretarder layer or a micropolarizer layer can be used as the parallax layer. The distance between the parallax layer and the organic electroluminescent device is minimized. So the view angle of the stereoscopic image display apparatus is increased.

### FIELD OF THE INVENTION

The present invention relates to a display apparatus and particularly to an organic electroluminescent stereoscopic image display apparatus and fabricating method thereof.

### BACKGROUND OF THE INVENTION

The 3D-display technique is considered as one of the most important research and development directions after the flat-panel display device. The stereoscopic vision, which people perceive with their two eyes in daily life, gives people the depth sense of the visual scenes. To display a stereoscopic image, two sets of overlaid images have to be provided to imitate the vision of two eyes. Then the two sets of images are perceived through polarized glasses or other means by the eyes to form the stereoscopic image.

The stereoscopic display device may be made in many ways. In order for the display device to simultaneously provide the two sets of images to the left eye and the right eye, one of the conventional stereoscopic display devices has two types of pixels to display the left eye image and the right eye image, and a polarizer or a phase retarder to encode the left eye image and the right eye image so that the light emitted from the two types of pixels are of two different conditions. For instance, U.S. Pat. No. 5,264,964 discloses a multi-mode stereoscopic imaging system, which has a micropolarizer bonding to the outmost layer of the display apparatus. The micropolarizer has two polarization states on two group of zones corresponding to different liquid crystal pixels for the left eye image and the right eye image respectively so that the light emitted from the liquid crystal pixels presents different polarization conditions. However, the display apparatus used in the previous method has a front glass interposed between the micropolarizer and the pixel layer. That causes a severe limitation of the viewing angle and results in suffering of the stereoscopic effect.

### SUMMARY OF THE INVENTION

In view of the aforesaid disadvantages occurred to the conventional techniques, the present invention aims to provide an organic electroluminescent stereoscopic image display apparatus and a fabricating method thereof. The display apparatus includes a parallax layer and an organic electroluminescent device. The parallax layer transfers image received by the right eye and the left eye to lights with different characteristics. The parallax layer and the organic electroluminescent device are close to each other to increase the viewing angle of the stereoscopic image display apparatus. The resulting organic electroluminescent stereoscopic image display apparatus equips the functions of both 2D display and stereoscopic display.

The organic electroluminescent stereoscopic image display apparatus according to the invention includes a parallax layer and an organic electroluminescent device. The organic electroluminescent device includes an organic electroluminescent layer, a transparent electrode layer and a metal electrode layer. The transparent electrode layer and the metal electrode layer are located respectively on two sides of the organic electroluminescent layer to excite the organic electroluminescent layer to emit light, when subject to an external voltage. The organic electroluminescent device has a light emission side on the organic electroluminescent layer where the transparent electrode layer is located. The light emission side is divided into a plurality of pixels to emit left eye image and right eye image. The parallax layer is located on the light emission side of the organic electroluminescent device to transfer the left eye image and the right eye image to lights with different characteristics. The organic electroluminescent stereoscopic image display apparatus of the invention is formed by arranging the relative positions of the organic electroluminescent device and various layers. The stereoscopic image display apparatus thus formed may be seen by wearing polarized glasses or become a planar display apparatus to be seen without wearing polarized glasses. It also may be coupled with other means to become an autostereoscopic display apparatus, seen without wearing polarized glasses.

The parallax layer may be a microretarder layer or a micropolarizer layer. The microretarder layer may include a microretarder film and a polarizer film. The microretarder film has two phase-retardation zones. When the microretarder film greattached to the polarizer film, it can encode the left eye image and the right eye image provided by the organic electroluminescent device to two different polarization directions. The microretarder film includes a plurality of first retardation phase zones and a plurality of second retardation phase zones that are laid alternately. The first retardation phase zones and the second retardation phase zones have different retardation phases. Another approach is to use the micropolarizer layer. The micropolarizer layer includes a plurality of first polarization zones and a plurality of second polarization zones that are laid alternately. The first polarization zones and the second polarization zones have orthogonal polarization directions.

The viewing angle of the stereoscopic image display apparatus depends on the distance between the display device and the micropolarizer layer or the microretarder layer. In conventional techniques, the micropolarizer sheet and the pixel layer (liquid crystal layer) of the display device are interposed by a front glass (about 0.7 mm) and a front polarizer film (about 0.1-0.2 mm). In the present invention, the microretarder layer and the organic electroluminescent device are interposed only by a polarizer film or a thin film polarizer, having a thickness of about 1 μm. When the micropolarizer layer is employed, it can be bonded closely to the organic electroluminescent device to provide a wide viewing angle. Because the microretarder layer or the micropolarizer layer is spaced from the organic electroluminescent device at a very short distance, there is almost no light leakage caused by angle inclination. Hence an optimum 3D effect may be achieved. The relationship may be indicated by the following equation:

$$ϕ = 2 \cdot {tan}^{- 1} ( \frac{b}{2 d} )$$

where ψ is the viewing angle, b is the width of the opaque zone between the pixels, and d is the distance between the microretarder layer or the micropolarizer layer and the pixel layer.

The present invention also provides a fabricating method of an organic electroluminescent stereoscopic image display apparatus. It includes the steps as follows: providing an organic electroluminescent device that includes an organic electroluminescent layer, a transparent electrode layer and a metal electrode layer. The transparent electrode layer and the metal electrode layer are located respectively on two sides of the organic electroluminescent layer to excite the organic electroluminescent layer to emit light when subject to an external voltage. The organic electroluminescent device has a light emission side on the organic electroluminescent layer where the transparent electrode layer is located. The light emission side is divided into a plurality of pixels to emit left eye image and right eye image. A parallax layer is provided and located on the light emission side of the organic electroluminescent device to transfer the left eye image and the right eye image to lights with different characteristics.

The organic electroluminescent device and the parallax layer may be fabricated separately and coupled together. Another approach is to fabricate the parallax layer on the organic electroluminescent device, or to fabricate the organic electroluminescent device on the parallax layer.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a sectional view of a first embodiment of the organic electroluminescent stereoscopic image display apparatus according to the invention.

FIG. 2 is a sectional view of a second embodiment of the organic electroluminescent stereoscopic image display apparatus according to the invention.

FIG. 3 is a sectional view of a third embodiment of the organic electroluminescent stereoscopic image display apparatus according to the invention.

FIG. 4 is a schematic view of corresponding pixels of a horizontal striped microretarder layer or micropolarizer layer and a light emission side.

FIG. 5 is a schematic view of corresponding pixels of a vertical striped microretarder layer or micropolarizer layer and a light emission side.

FIG. 6 is a schematic view of corresponding pixels of a checker type microretarder layer or micropolarizer layer and a light emission side.

### DESCRIPTION OF THE PREFERRED EMBODIMENTS

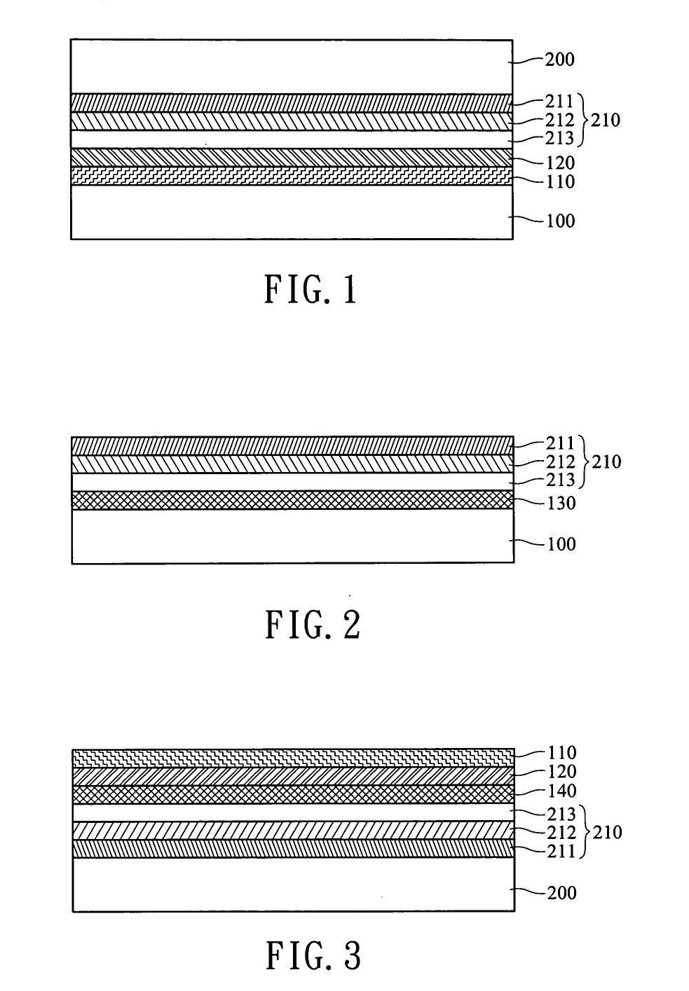

In the organic electroluminescent stereoscopic image display apparatus according to the invention, a microretarder layer in the parallax layer is used as an example. It includes a microretarder film and a polarizer film. Refer to FIG. 1 for the cross section of a first embodiment of the organic electroluminescent stereoscopic image display apparatus.

As shown in FIG. 1, the organic electroluminescent stereoscopic image display apparatus includes a transparent substrate 100 with a microretarder film 110 and a polarizer film 120, formed on the surface bonding to a holding substrate 200 with an organic electroluminescent device 210 located thereon. The organic electroluminescent device 210 includes an organic electroluminescent layer 212, a transparent electrode layer 213 and a metal electrode layer 211. The transparent electrode layer 213 and the metal electrode layer 211 are located respectively on two sides of the organic electroluminescent layer 212 to excite the organic electroluminescent layer 212 to emit light when subject to an external voltage. One side of the organic electroluminescent layer 212 that has a transparent electrode layer 213 located thereon serves as a light emission side of the organic electroluminescent device 210.

The organic electroluminescent stereoscopic image display apparatus may be fabricated by forming the microretarder layer and the polarizer layer on the transparent substrate, and forming the organic electroluminescent device on the holding substrate, then coupling the two substrates at a small interval (may be smaller than 100 μm). The fabrication process is as follows: cleaning and drying a flat substrate as the holding substrate; placing the holding substrate into a vaporization plating chamber to be treated with oxygen plasma; forming a metal electrode layer from sliver in a plurality of parallel stripes on the substrate by vaporization plating through a metal mask; treating with oxygen plasma again to form a thin Ag₂O layer on the surface; vaporization plating the following in this order: CuPc at a thickness of 15 nm to serve as an electric hole injection layer, 60 nm of NPB as an electric hole transport layer, 40 nm of Alq₃ and C545T co-plating layer as a light emission layer, 30 nm of Alq₃ on the light emission layer as an electron transport layer, and 0.5 nm of LiF and 10 nm of aluminum as a transparent electrode layer to finish the fabrication of the organic electroluminescent device on the holding substrate.

Next, fabricating a microretarder film and a polarizer film, or a micropolarizer layer on another transparent substrate. To fabricate the microretarder film and the polarizer film, first, forming the microretarder layer on the transparent substrate; then forming the polarizer film on the microretarder layer. On the other hand, the micropolarizer layer may be directly formed on the transparent substrate. Finally, the micropolarizer film or microretarder layer of the transparent substrate is aligned with the cathode of the holding substrate. Then a planar layer made of epoxy resin and cured by violet light is used to bond the two substrates as closely as possible to complete the fabrication of the organic electroluminescent stereoscopic image display apparatus.

Refer to FIG. 2 for the cross section of a second embodiment of the organic electroluminescent stereoscopic image display apparatus. It has a transparent substrate containing a micropolarizer layer. The organic electroluminescent layer 212, transparent electrode layer 213 and metal electrode layer 211 are directly fabricated thereon through a film fabrication process to form the organic electroluminescent device. Hence there is no need to use the epoxy resin for bonding. However, before fabricating the organic electroluminescent device, a planar layer may be added to flatten the bonding surface and isolate the micropolarizer layer and the organic electroluminescent device.

Refer to FIG. 3 for the cross section of a third embodiment of the organic electroluminescent stereoscopic image display apparatus. It includes a holding substrate 200 with an organic electroluminescent device 210 located thereon. The organic electroluminescent device 210 includes a metal electrode layer 211, an organic electroluminescent layer 212 and a transparent electrode layer 213 in this order. The transparent electrode layer 213 and the metal electrode layer 211 are located on two sides of the organic electroluminescent layer 212 to excite the organic electroluminescent layer 212 to emit light when subject to an external voltage. One side of the organic electroluminescent layer 212 that has a transparent electrode layer 213 located thereon serves as a light emission side of the organic electroluminescent device 210. On the transparent electrode layer 213, a planar layer 140, a polarizer film 120 and a microretarder film 110 are formed in this order.

The fabrication process of the organic electroluminescent stereoscopic image display apparatus set forth above is as follows: placing the holding substrate into a vaporization plating chamber to be treated with oxygen plasma; forming an anode from sliver in a plurality of parallel stripes on the holding substrate by vaporization plating through a metal mask; treating with oxygen plasma again to form a thin Ag₂O layer on the surface; vaporization plating the following in this order: CuPc at a thickness of 15 nm to serve as an electric hole injection layer, 60 nm of NPB, as an electric hole transport layer, 40 nm of Alq₃ and C545T co-plating layer as a light emission layer, 30 nm of Alq₃ on the light emission layer as an electron transport layer, and 0.5 nm of LiF and 10 nm of aluminum as a transparent electrode layer to finish the fabrication of the organic electroluminescent device on the holding substrate. Then form a planar layer on the organic electroluminescent device, and fabricate a polarizer film and a microretarder film on the planar layer in this order.

The parallax layer (i.e. the microretarder layer or the micropolarizer layer) may have a pattern in the form of horizontal stripes, vertical stripes or a checker format. The microretarder layer includes a first retardation phase zone and a second retardation phase zone, that are formed alternately and have different retardation phases. The micropolarizer layer has a first polarization direction zone and a second polarization direction zone that are formed alternately and have different polarization directions. The light emission side of the organic electroluminescent device contains a plurality of pixels. Each pixel or sub-pixel (i.e. the R, G, B portion of one pixel) corresponds to the first retardation phase zone and the second retardation phase zone of the microretarder layer or the first polarization direction zone and the second polarization direction zone of the micropolarizer layer, and is divided into two sets, to provide respectively the left eye image and the right eye image. Hence the width of the stripes or the square of the microretarder layer or the micropolarizer layer may be the width of one pixel or an integer number of pixels, or the width of a subpixel (i.e. one third of a pixel).

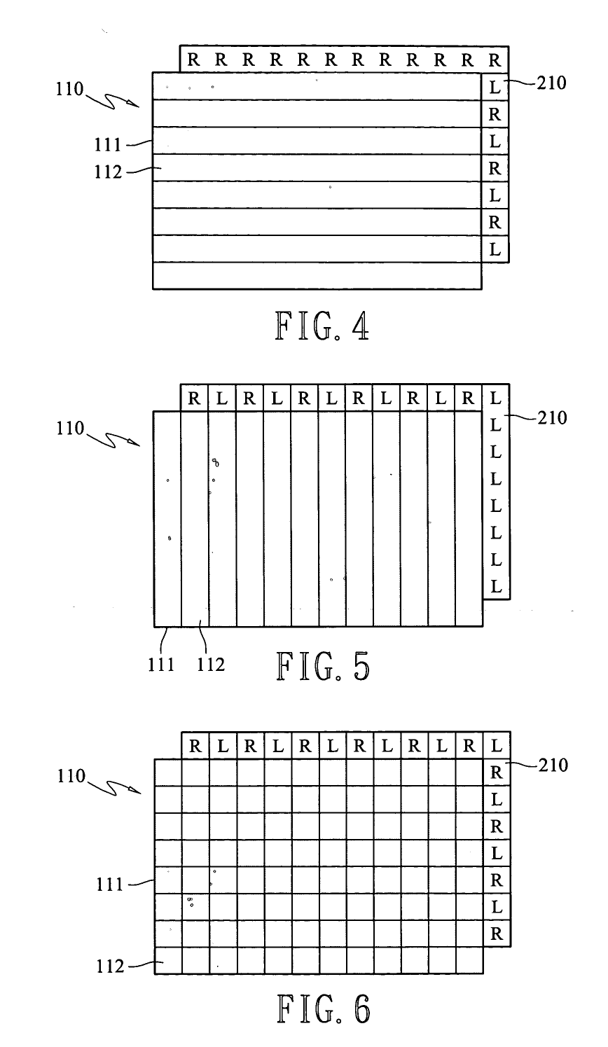

Refer to FIG. 4 for a schematic view of corresponding pixels of a horizontal striped microretarder layer and the light emission side. The microretarder film 110 includes a first retardation phase zone 111 and a second retardation phase zone 112 that are formed in horizontal stripes and laid alternately. The micropolarizer film 130 has a first polarization direction zone 131 and a second polarization direction zone 132 that are formed in horizontal stripes. The pixels on the light emission side of the organic electroluminescent device 210 are divided into two sets corresponding to the first retardation phase zone 111 and the second retardation phase zone 112. The two sets of pixels also are laid horizontally in stripes and laid alternately to provide respectively the left eye image and the right eye image. The pixels marked by R provide the right eye image, and the pixels marked by L provide the left eye image.

Refer to FIG. 5 for a schematic view of corresponding pixels of a vertical striped microretarder layer and the light emission side. The microretarder layer 110 includes a first retardation phase zone 111 and a second retardation phase zone 112 that are formed in vertical stripes and laid alternately. The pixels on the light emission side of the organic electroluminescent device 210 are divided into two sets corresponding to the first retardation phase zone 111 and the second retardation phase zone 112. The two sets of pixels also are laid vertically and alternately to provide the left eye image and the right eye image. The pixels marked by R provide the right eye image, and the pixels marked by L provide the left eye image.

Refer to FIG. 6 for a schematic view of corresponding pixels of a checker type microretarder layer and the light emission side. The microretarder layer 110 includes a first retardation phase zone 111 and a second retardation phase zone 112 that are formed in a checker format and alternately. The pixels on the light emission side of the organic electroluminescent device 210 are divided into two sets corresponding to the first retardation phase zone 111 and the second retardation phase zone 112. The two sets of pixels also are laid in a checker format and laid alternately to provide the left eye image and the right eye image. The pixels marked by R provide the right eye image, and the pixels marked by L provide the left eye image.

Similarly, the first polarization direction zones and the second polarization direction zones of the micropolarizer layer may be formed in horizontal stripes, vertical stripes or a checker format, and laid alternately.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments, which do not depart from the spirit and scope of the invention.

1. An organic electroluminescent stereoscopic image display apparatus, comprising:
an organic electroluminescent device, having an organic electroluminescent layer, a transparent electrode layer and a metal electrode layer, the transparent electrode layer and the metal electrode layer located respectively on two sides of the organic electroluminescent layer to excite the organic electroluminescent layer to emit light when subject to an external voltage, the organic electroluminescent layer having a light emission side on one side where the transparent electrode layer is located, the light emission side having a plurality of pixels to emit a left eye image and a right eye image; and
a parallax layer, located on the light emission side of the organic electroluminescent device to transfer the left eye image and the right eye image to lights with different characteristics.

2. The organic electroluminescent stereoscopic image display apparatus of claim 1, wherein the parallax layer includes a microretarder film and a polarizer film, the microretarder film including a plurality of first retardation phase zones and a plurality of second retardation phase zones that are laid alternately and have different retardation phases.

3. The organic electroluminescent stereoscopic image display apparatus of claim 2, wherein the first retardation phase zones and the second retardation phase zones are formed in horizontal stripes, vertical stripes or in a checker format, and laid alternately.

4. The organic electroluminescent stereoscopic image display apparatus of claim 1, wherein the parallax layer is a micropolarizer layer, which includes a plurality of first polarization zones and a plurality of second polarization zones that are laid alternately and in different polarization directions.

5. The organic electroluminescent stereoscopic image display apparatus of claim 4, wherein the first polarization zones and the second polarization zones are formed in horizontal stripes, vertical stripes or in a checker format, and laid alternately.

6. The organic electroluminescent stereoscopic image display apparatus of claim 1 further including a planar layer interposed between the microretarder layer and the organic electroluminescent device.

7. The organic electroluminescent stereoscopic image display apparatus of claim 1, wherein the pixels are divided into two sets to provide respectively the left eye image and the right eye image.

8. The organic electroluminescent stereoscopic image display apparatus of claim 1, wherein each of the pixels contains three subpixels to display respectively red, blue and green.

9. The organic electroluminescent stereoscopic image display apparatus of claim 8, wherein the subpixels are divided into two sets to provide the left eye image and the right eye image.

10. The organic electroluminescent stereoscopic image display apparatus of claim 1, further including a transparent substrate abutting the microretarder layer.

11. The organic electroluminescent stereoscopic image display apparatus of claim 1 further including a holding substrate abutting one side of the organic electroluminescent layer, where the metal electrode is located.

12. The organic electroluminescent stereoscopic image display apparatus of claim 1, wherein the organic electroluminescent layer includes an electric hole injection layer, an electric hole transport layer, a light emission layer and an electron transport layer and combinations thereof.

13. A fabricating method of organic electroluminescent stereoscopic image display apparatus, comprising the steps of:
providing an organic electroluminescent device which includes an organic electroluminescent layer, a transparent electrode layer and a metal electrode layer, the transparent electrode layer and the metal electrode layer located respectively on two sides of the organic electroluminescent layer to excite the organic electroluminescent layer to emit light when subject to an external voltage, the organic electroluminescent layer having a light emission side on one side, where the transparent electrode layer is located, the light emission side divided into a plurality of pixels to emit a left eye image and a right eye image; and
setting a parallax layer on the light emission side of the organic electroluminescent device to transfer the left eye image and the right eye image to lights with different characteristics.

14. The method of claim 13, wherein the parallax layer is located on a transparent substrate, and the transparent electrode layer, the organic electroluminescent layer and the metal electrode layer are stacked on the parallax layer to form the organic electroluminescent device.

15. The method of claim 13, wherein the metal electrode layer, the organic electroluminescent layer and the transparent electrode layer are stacked on a holding substrate in this order to form the organic electroluminescent device, the parallax layer located on the light emission side.

16. The method of claim 13, wherein the parallax layer is located on a transparent substrate, the metal electrode layer, the organic electroluminescent layer and the transparent electrode layer stacked on a holding substrate in this order to form the organic electroluminescent device, the parallax layer bonded to the transparent electrode layer.

17. The method of claim 13, wherein the parallax layer includes a microretarder film and a micropolarizer film, the microretarder film including a plurality of first retardation phase zones and a plurality of second retardation phase zones that are laid alternately and have different retardation phases.

18. The method of claim 17, wherein the first retardation phase zones and the second retardation phase zones are formed in horizontal stripes, vertical stripes or in a checker format, and laid alternately.

19. The method of claim 13, wherein the microretarder layer is a micropolarizer film, which includes a plurality of first polarization zones and a plurality of second polarization zones that are laid alternately and have different polarization directions.

20. The method of claim 19, wherein the first polarization zones and the second polarization zones are formed in horizontal stripes, vertical stripes or in a checker format, and laid alternately.

21. The method of claim 13 further including the step of interposing a planar layer between the microretarder layer and the organic electroluminescent device.

22. The method of claim 13, wherein the pixels are divided into two sets to provide the left eye image and the right eye image.

23. The method of claim 13, wherein each of the pixels contains three subpixels to display respectively red, blue and green.

24. The method of claim 13, wherein the subpixels are divided into two sets to provide the left eye image and the right eye image.

25. The method of claim 13, wherein the organic electroluminescent layer includes an electric hole injection layer, an electric hole transport layer, a light emission layer and an electron transport layer and combinations thereof.
